(19) United States
(12) Patent Application Publication
(10) Pub. No.: US 2025/0340073 A1
(43) Pub. Date: Nov. 6, 2025

(54) PRINTING APPARATUS

(71) Applicant: CANON KABUSHIKI KAISHA, Tokyo (JP)

(72) Inventor: TAKAAKI AOYAGI, Kanagawa (JP)

(21) Appl. No.: 19/195,841

(22) Filed: May 1, 2025

(30) Foreign Application Priority Data
May 2, 2024 (JP) 2024-074733

(51) Int. Cl. B41J 11/00

(52) U.S. Cl. CPC B41J 11/0045; B41J 11/006

(57) ABSTRACT

A printing apparatus includes a main body, a printing unit to print an image on a print medium, a loading unit to load multiple print media, a feeding roller to feed the print media loaded on the loading unit, a guide unit configured to be detachable from the main body and form a part of a conveyance path for conveying the print media from the feeding roller to the printing unit, and a separation member detachably held by the guide unit and configured to separate one of multiple print media from the others in a case where the multiple print media are fed by the feeding roller. The guide unit includes at least one restriction unit configured to be moved by an operation portion between positions where the restriction unit is engaged with and disengaged from the main body.

### BACKGROUND OF THE INVENTION

### Field of the Invention

The present disclosure relates to a printing apparatus, and specifically relates to a printing apparatus with a replaceable separation member for preventing multi-feeding of print media.

### Description of the Related Art

A printing apparatus such as a printer or a copier is equipped with a feeder unit configured to feed a print medium to a printing unit. This feeder unit includes a separation member such as a separation roller for separating print media one by one in order to prevent multi-feeding in which two or more print media are fed at one time.

However, in some cases, the separation member is worn down due to friction with print media, resulting in a condition where the separation member deteriorates and is decreased in print media separation performance. To address this, some printing apparatus has a structure for replacing a separation member decreased in the print media separation performance due to the wearing. Japanese Patent Laid-Open No. 2014-172735 (referred to as Document 1 below) discloses a printing apparatus including a replaceable separation roller. In the printing apparatus disclosed in Document 1, the separation roller is replaced by opening an exterior cover and detaching a roller attachment unit to which the separation roller is attached.

However, the structure for replacing the separation roller described in Document 1 requires a laborious task of opening the exterior cover, making the operation for replacement cumbersome.

### SUMMARY OF THE INVENTION

A printing apparatus in the disclosure includes: a main body; a printing unit configured to print an image on a print medium; a loading unit configured to load a plurality of print media; a feeding roller configured to feed the print media loaded on the loading unit; a guide unit configured to be detachable from the main body and form a part of a conveyance path through which the print media are conveyed from the feeding roller to the printing unit; and a separation member detachably held by the guide unit, and configured to separate one of a plurality of print media from the other print media in a case where the plurality of print media are fed by the feeding roller. The guide unit includes at least one restriction unit configured to be moved by an operation portion between a position where the restriction unit is engaged with the main body and a position where the restriction unit is disengaged from the main body.

Further features of the present invention will become apparent from the following description of exemplary embodiments with reference to the attached drawings.

### BRIEF DESCRIPTION OF THE DRAWINGS

FIG. 1A is a perspective view illustrating a printing apparatus according to the embodiment;

FIG. 1B is a perspective view illustrating an opened state of the printing apparatus according to the embodiment;

FIG. 2 is a perspective view illustrating the printing apparatus according to the embodiment excluding a part of a main body;

FIG. 3 is a schematic cross-sectional view illustrating an inside of the printing apparatus according to the embodiment excluding a part of the main body;

FIG. 4 is a cross-sectional view illustrating a portion a of the printing apparatus illustrated in FIG. 3 in an enlarged manner;

FIG. 5A is a diagram for explaining forces acting on a print medium while the print medium is passing through a nip portion between a first separation roller and a second separation roller in the printing apparatus according to the embodiment;

FIG. 5B is a diagram for explaining how the first separation roller and the second separation roller of the printing apparatus according to the embodiment separate one of multiple print media from the others and convey the print medium;

FIG. 6A is a perspective view illustrating a state where a guide unit is attached to the main body of the printing apparatus according to the embodiment;

FIG. 6B is a perspective view illustrating a state where the guide unit is detached from the main body of the printing apparatus according to the embodiment;

FIG. 7A is a cross-sectional view of the guide unit according to the embodiment, illustrating a structure for attaching the guide unit;

FIG. 7B is a cross-sectional view of the guide unit according to the embodiment, illustrating a structure for detaching the guide unit;

FIG. 8A is a conceptual diagram illustrating a state where the second separation roller is attached to the guide unit in a case where the guide unit is detached from the main body according to the embodiment;

FIG. 8B is a conceptual diagram illustrating a state where the second separation roller is detached from the guide unit in the case where the guide unit is detached from the main body according to the embodiment;

FIG. 9A is a conceptual diagram illustrating a state where the second feeding roller and a first separation roller are attached to the main body in a case where the guide unit is detached from the main body according to the embodiment;

FIG. 9B is a conceptual diagram illustrating a state where the second feeding roller and the first separation roller are detached from the main body in the case where the guide unit is detached from the main body according to the embodiment;

FIG. 10 is a perspective view illustrating a guide unit detached from a main body of a printing apparatus according to a second embodiment of the present disclosure;

FIG. 11A is a cross-sectional view of the guide unit according to the second embodiment of the present disclosure, illustrating a structure for attaching the guide unit;

FIG. 11B is a cross-sectional view of the guide unit according to the second embodiment of the present disclosure, illustrating a structure for detaching the guide unit;

FIG. 12A is a cross-sectional view of a guide unit according to a third embodiment of the present disclosure, illustrating a structure for attaching the guide unit;

FIG. 12B is a cross-sectional view of the guide unit according to the third embodiment of the present disclosure, illustrating a structure for detaching the guide unit;

FIG. 13A is a top view of the guide unit according to the third embodiment of the present disclosure, illustrating the structure for attaching the guide unit; and

FIG. 13B is a top view of the guide unit according to the third embodiment of the present disclosure, illustrating the structure for detaching the guide unit.

### DESCRIPTION OF THE EMBODIMENTS

Hereinafter, embodiments for carrying out the present disclosure will be described in detail with reference to the drawings. However, the dimensions, materials, shapes, and relative positions of constituent components in the following embodiments can be altered as appropriate depending on structures and various conditions of a printing apparatus to which the present disclosure is applied. The scope of the present disclosure should not be limited to the following embodiments.

### Embodiment 1

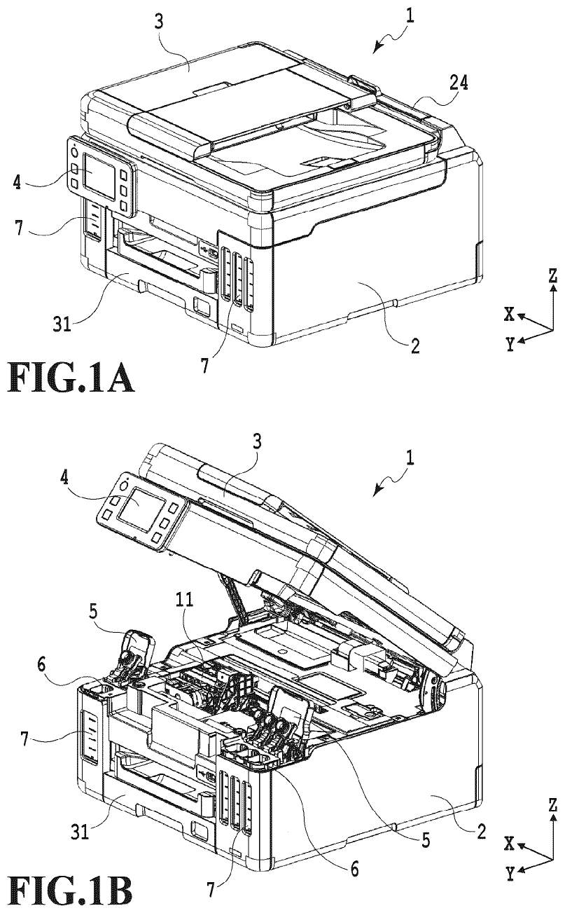

FIG. 1A is a perspective view illustrating a printing apparatus 1 according to the embodiment. As illustrated in FIG. 1A, in the printing apparatus 1, a reading device 3 is provided on top of a main body 2 so as to be openable and closable, and a touch panel-type display device 4 for receiving user operations is provided in one side surface of the main body 2.

FIG. 1B is a perspective view illustrating an opened state of the printing apparatus 1 according to the embodiment. As illustrated in FIG. 1B, in the opened state of the printing apparatus 1, the main body 2 of the printing apparatus 1 is opened, and ink tank covers 5 provided to the main body 2 are opened to expose ink inlets 6 to outside, so that inks can be injected from the ink inlets 6 into ink tanks 7.

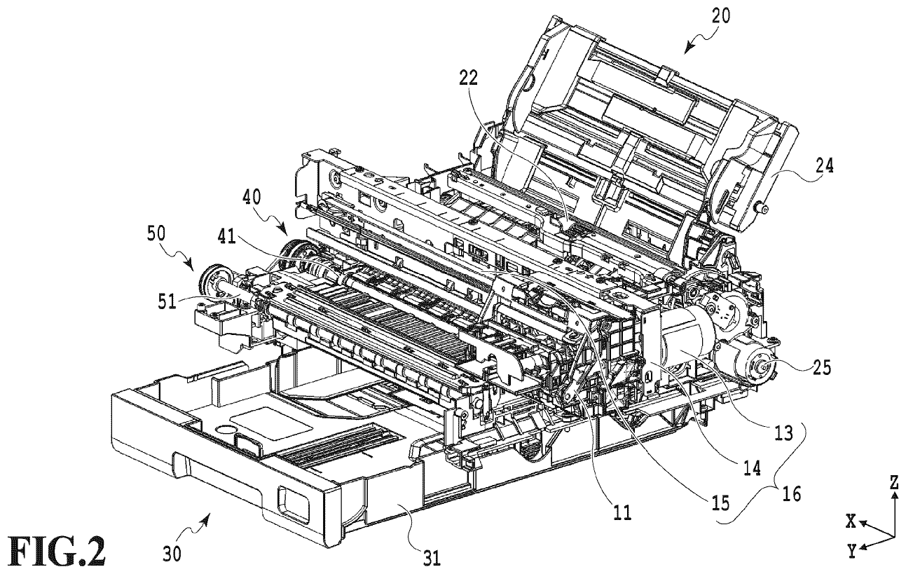

In FIGS. 1A and 1B, arrows X, Y, and Z orthogonal to each other indicate a width direction, a depth direction, and a height direction of the printing apparatus 1, respectively. Moreover, in FIGS. 2 to 13, arrows X, Y, and Z indicate the same directions as the directions illustrated in FIG. 1.

The printing apparatus 1 in the embodiment is a serial inkjet printing apparatus configured to print an image by ejecting the inks supplied from the ink tanks 7 onto a print medium. Instead, the present disclosure may be applied to another type of serial printing apparatus.

In the embodiment, “printing” refers not only to forming meaningful information such as characters and figures but also broadly to forming a meaningful or meaningless image, design, pattern, or the like on a print medium or processing the medium regardless of whether or not the formed product is noticeable so that humans can perceive it visually. In the embodiment, the print medium is in a sheet form. Specifically, paper in a sheet form may be applied as the print medium. In another embodiment, a cloth, a plastic film, or the like may be applied as the print medium.

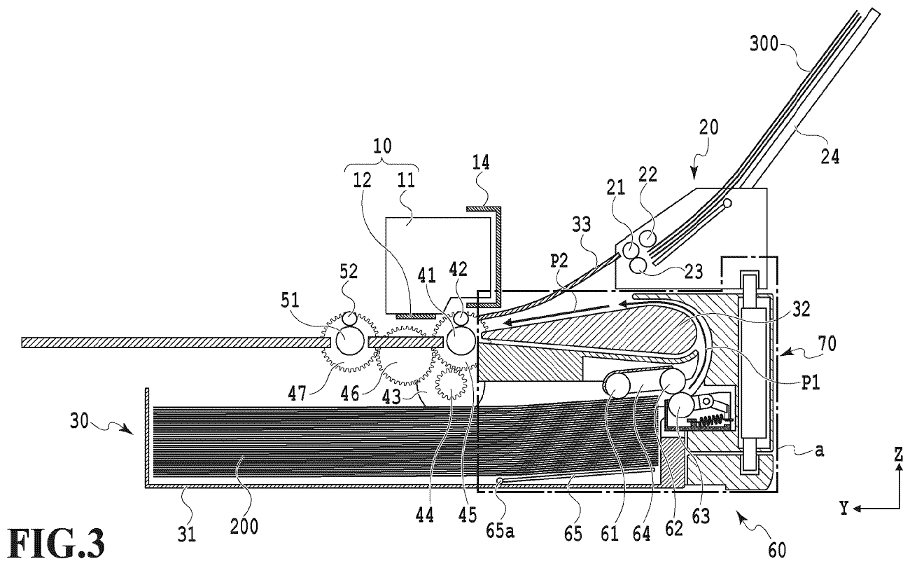

FIG. 2 is a perspective view illustrating the printing apparatus 1 according to the embodiment excluding a part of the main body 2. FIG. 3 is a schematic cross-sectional view illustrating an inside of the printing apparatus 1 according to the embodiment excluding a part of the main body 2. As illustrated in FIGS. 2 and 3, the printing apparatus 1 includes a first feeder unit 20, a second feeder unit 30, a conveyor unit 40, and a delivery unit 50 in order to convey print media 200.

In the embodiment, a sub-scanning direction, which is a direction in which the print medium 200 is conveyed, is the Y direction in a plan view of the printing apparatus 1, a side from which the print medium 200 is conveyed is defined as an upstream side, and a side to which the print medium 200 is conveyed is defined as a downstream side.

The printing apparatus 1 in the embodiment includes a first feeding route for feeding a print medium 200 from the first feeder unit 20 and a second feeding route for feeding a print medium 200 from the second feeder unit 30, and is capable of selectively using either of the first feeding route and the second feeding route for feeding a print medium 200.

In detail, the first feeder unit 20 includes three feeding rollers 21, 22, and 23 each having an axial direction in parallel with the X direction. The feeding rollers 21 and 22 are configured to be rotated by a driving force of a driving source 25 (for example, a motor) and convey a print medium 300 loaded on a loading tray 24 disposed at a rear portion of the main body 2.

The loading tray 24 of the printing apparatus 1 in the embodiment can be unfolded from a stored state as illustrated in FIG. 1A to an opened state as illustrated in FIG. 2.

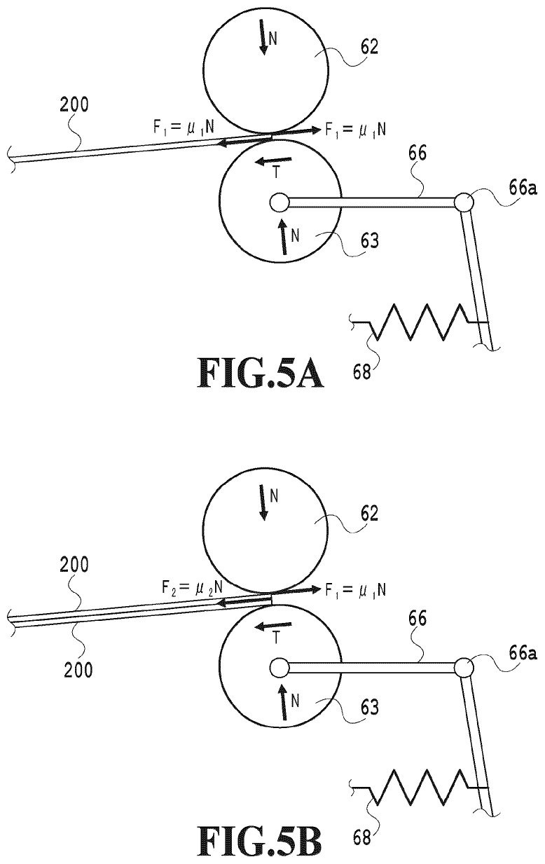

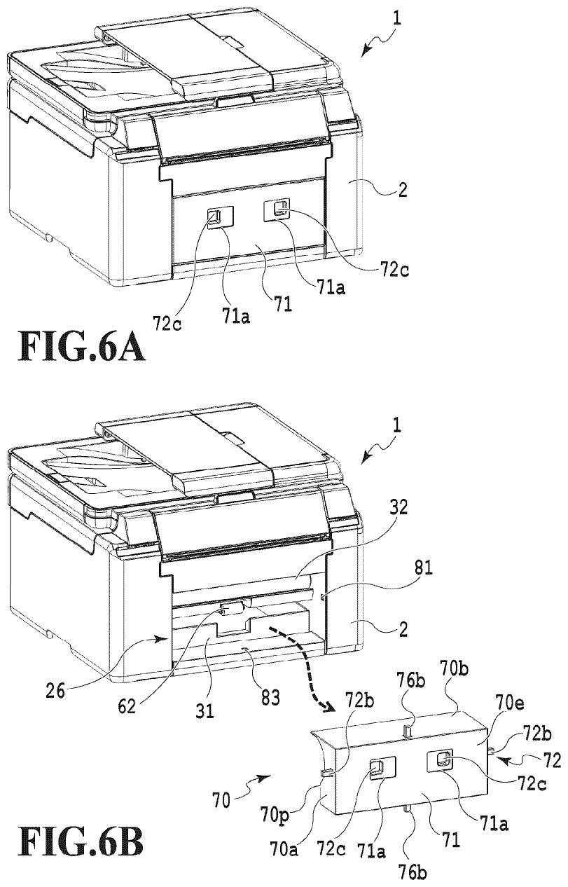

The second feeder unit 30 is disposed at a bottom portion of the main body 2 of the printing apparatus 1, and includes a feeder cassette 31 which is detachably inserted along the Y direction from a front side of the main body 2 of the printing apparatus 1. Each of the print media 200 stored in the feeder cassette 31 is fed to the conveyor unit 40 while bypassing a rear side of the main body 2 of the printing apparatus 1. In detail, the print media 200 stored in the feeder cassette 31 are pressed against a feeding roller 61 by a pressure plate 65. With rotations of the feeding roller 61 in the above state, each print medium 200 is fed, passes between a first separation roller 62 as a separation member and a second separation roller 63 also as a separation member, and then passes through a conveyance path P1 formed between a guide unit 70 and an internal guide 32 of the main body 2. A separation action by the first separation roller 62 and the second separation roller 63 will be described later in reference to FIGS. 5A and 5B. After passing through the conveyance path P1, the print medium 200 passes through a conveyance path P2 formed between the internal guide 32 and an upper side guide 33 and reaches the conveyor unit 40. The guide unit 70 constituting this conveyance path is configured to be detachably attachable to the main body 2 as will be described later in reference to FIG. 6 and others, which makes it possible to replace the second separation roller 63.

The conveyor unit 40 is disposed downstream of the first feeder unit 20 and includes a conveyance roller 41 having an axial direction in parallel with the X direction. Rotations of a driving source 43 (for example, a motor) are transmitted to the conveyance roller 41 via drive transmission units 44 and 45, thereby enabling the conveyance roller 41 to rotate so as to convey the print medium 300 or 200 conveyed from the first feeder unit 20 or the second feeder unit 30. In detail, a driven roller 42 is pressed against the conveyance roller 41 and the print medium 300 or 200 is conveyed through a nip portion between the conveyance roller 41 and the driven roller 42.

The delivery unit 50 is disposed downstream of the conveyor unit 40 and includes a delivery roller 51 having an axial direction in parallel with the X direction. The rotations of the driving source 43 are transmitted to the delivery roller 51 via four drive transmission units 44, 45, 46, and 47, thereby enabling the delivery roller 51 to rotate to deliver the print medium 300 or 200 conveyed from the conveyor unit 40. In the embodiment, a spur 52 is pressed against the delivery roller 51 and the print medium 300 or 200 is conveyed through a nip portion between the delivery roller 51 and the spur 52.

A printing unit 10 is configured to print an image on the print medium 300 or 200. The printing unit 10 includes a carriage 11. A print head 12 mounted in a bottom portion of the carriage 11 includes multiple ejection orifices for ejecting the inks, and ejects the inks supplied from the ink tanks 7 illustrated in FIG. 1 via ink supply tubes (not illustrated), thereby forming an image on the print medium 300 or 200 being conveyed by the conveyor unit 40.

In the embodiment, the printing unit 10 illustrated in FIGS. 2 and 3 includes a driving mechanism 16 configured to reciprocate the carriage 11 in a predetermined direction (main scanning direction). In the embodiment, the main scanning direction, which is the reciprocating direction of the carriage 11, is the X direction illustrated in FIG. 2. Here the movement of the carriage 11 is defined as scanning and printing an image by the print head 12 while the carriage 11 is being moved is defined as print scanning. The driving mechanism 16 for driving the carriage 11 includes a guide rail 14 configured to guide the movement of the carriage 11 in the main scanning direction, and a belt transmission mechanism 15 configured to transmit a driving force from a driving source 13 (for example, a motor) to the carriage 11 to move the carriage 11 in the main scanning direction.

In the embodiment, the print medium 300 or 200 fed from the first feeder unit 20 or the second feeder unit 30 is conveyed intermittently by the conveyor unit 40 and the conveyance of the print medium 300 or 200 and the printing of the image by the printing unit 10 are alternately performed.

Specifically, the conveyor unit 40 conveys the print medium 200 or 300 to a line position (position in the sub-scanning direction) for image formation by the printing unit 10 and stops the conveyance of the print medium 200 or 300 at the line position. While the conveyance of the print medium 200 or 300 is stopped, the carriage 11 is moved to perform the print scanning. Subsequently, the conveyor unit 40 conveys the print medium 200 or 300 to the next line position, and then the same procedures are repeated. As a result, the image can be formed on the entire print medium 200 or 300. After the printing of the image is completed, the delivery unit 50 delivers the print medium 200 or 300 from the main body 2.

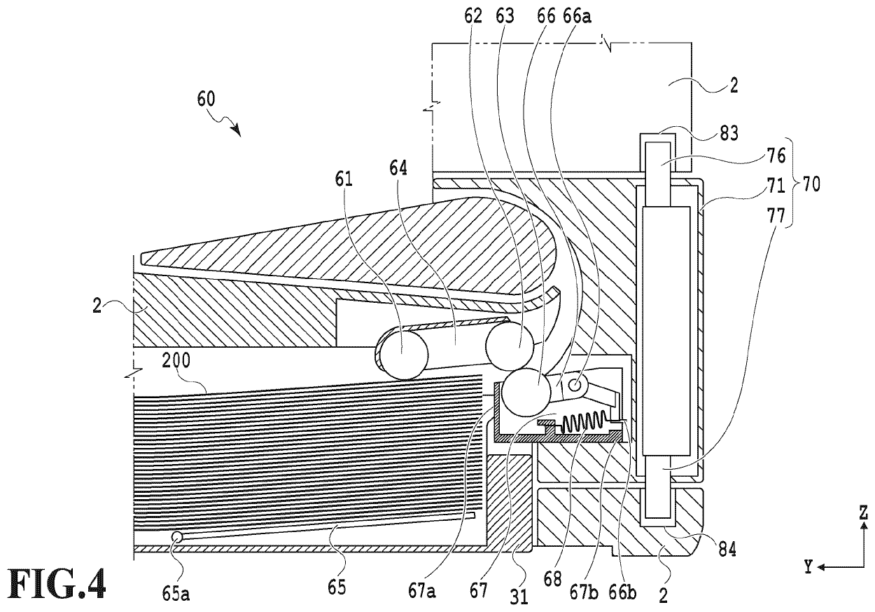

FIG. 4 is a cross-sectional view illustrating a portion a of the printing apparatus illustrated in FIG. 3 in an enlarged manner. As illustrated in FIG. 4, the feeding roller 61 and the first separation roller 62 are rotatably attached to a first holder 64 fixed to the main body 2.

The pressure plate 65 installed in a storage space of the feeder cassette 31 is turnable about a turn center 65a. With the pressure plate 65 turned about the turn center 65a by a driving source (not illustrated), one end of the pressure plate 65 is raised to bring the print media 200 loaded on the feeder cassette 31 into contact with the feeding roller 61 and press the print media 200 against the feeding roller 61.

Here, in a case where the feeding roller 61 rotates with a print medium 200 put in contact with the feeding roller 61, the print medium 200 is conveyed to the nip portion between the first separation roller 62 and the second separation roller 63. In detail, the driving force provided by the driving source 25 is transmitted to the feeding roller 61 and the first separation roller 62, so that the feeding roller 61 and the first separation roller 62 rotate so as to convey the print medium 200 to the conveyance path P1 (downstream side).

The second separation roller 63 is attached to an arm 66 rotatably, and the arm 66 is fixed to a second holder 67 so as to be turnable around a turn center 66a. A torque limiter (not illustrated) is provided to a rotation center of the second separation roller 63, and the arm 66 is configured to be biased by a spring 68 to bring the second separation roller 63 into pressure contact with the first separation roller 62. In a case where two or more print media 200 are stuck to each other due to friction between the print media and conveyed together to the nip portion between the first separation roller 62 and the second separation roller 63, the two or more print media 200 are separated upon contact with a wall surface 67a of the second holder 67 and are conveyed to the nip portion between the first separation roller 62 and the second separation roller 63.

FIG. 5A is a diagram for explaining forces acting on a print medium 200 while the print medium 200 is passing through the nip portion between the first separation roller 62 and the second separation roller 63 in the printing apparatus according to the embodiment. As illustrated in FIG. 5A, a single print medium 200 enters the nip portion between the first separation roller 62 and the second separation roller 63 and receives a force F1 in a feeding direction from the rotating first separation roller 62. This force F1 acts so as to rotate the second separation roller 63, but the second separation roller 63 is stopped from rotating by the torque limiter, and as a result, the print medium 200 receives the force F1 in the direction opposite to the feeding direction. With this force F1, a clockwise moment about the turn center 66a is generated in the second separation roller 63 and the arm 66, so that a pressure contact force N between the first separation roller 62 and the second separation roller 63 increases. As this pressure contact force N increases and exceeds the limit of the torque limiter of the second separation roller 63, the second separation roller 63 starts rotating and allows the print medium 200 to pass through the nip portion. In other words, the torque limiter rotates idly and the second separation roller 63 is driven and rotated under the condition where a relationship F₁=μ₁N>T is satisfied, where T denotes a conveyance resistance set by the torque limiter (not illustrated) provided to the second separation roller 63, and μ₁ denotes a frictional coefficient between the first and second separation rollers 62 and 63 and the print medium 200, in short, the force F₁ becomes greater than the conveyance resistance T. As a result, the print medium 200 is fed to the downstream side. Even in a case where the print medium 200 is not located at the nip portion between the first separation roller 62 and the second separation roller 63, the second separation roller 63 may be driven and rotated by the first separation roller 62 based on the same principle.

FIG. 5B is a diagram for explaining how the first separation roller 62 and the second separation roller 63 in the printing apparatus according to the embodiment separate one of multiple print media from the others and convey the print medium, in short, prevent multi-feeding. As illustrated in FIG. 5B, in a case where two print media 200 enter the nip portion between the first separation roller 62 and the second separation roller 63, a frictional coefficient μ₂ between the two print media 200 is smaller than the frictional coefficient μ₁ between the first and second separation rollers 62 and 63 and the print medium 200. In other words, the relationship between the force F₁ received by the upper print medium 200 from the first separation roller 62 and a force F₂ received by the upper print medium 200 from the lower print medium 200 is F₁=μ₁N>F₂₌₁₂N. In a case where the conveyance resistance T is set appropriately by the torque limiter, F₁=μ₁N>T>F₂=μ₂N holds. Since the conveyance resistance Tis greater than the force F₂, the torque limiter stops the rotation of the second separation roller 63, thereby stopping the conveyance of the lower print medium 200. Since the force F₁ received by the upper print medium 200 from the first separation roller 62 is greater than the force F₂ received by the upper print medium 200 from the lower print medium 200, the two print media 200 slide on each other and only the upper print medium 200 is fed through the nip portion.

FIG. 6A is a perspective view illustrating a state where the guide unit 70 in the printing apparatus according to the embodiment is attached to the main body 2. FIG. 6B is a perspective view illustrating a state where the guide unit 70 in the printing apparatus according to the embodiment is detached from the main body 2. As illustrated in FIG. 6B, the guide unit 70 includes a guide surface 70p and an exterior surface 70e opposed to the guide surface 70p. The guide surface 70p and the internal guide 32 (see FIG. 3) together form the conveyance path P1 (see FIG. 3) for conveying the print medium 200. The guide unit 70 is attached to a housing portion 26 of the main body 2 in a posture where the guide surface 70p faces the housing portion 26 of the main body 2. In the state where the guide unit 70 is attached to the main body 2, the exterior surface 70e of the guide unit 70 is exposed continuously from the exterior of the main body 2 as illustrated in FIG. 6A.

Hereinafter, description will be given of structures for attaching and detaching the guide unit 70 to and from the main body 2.

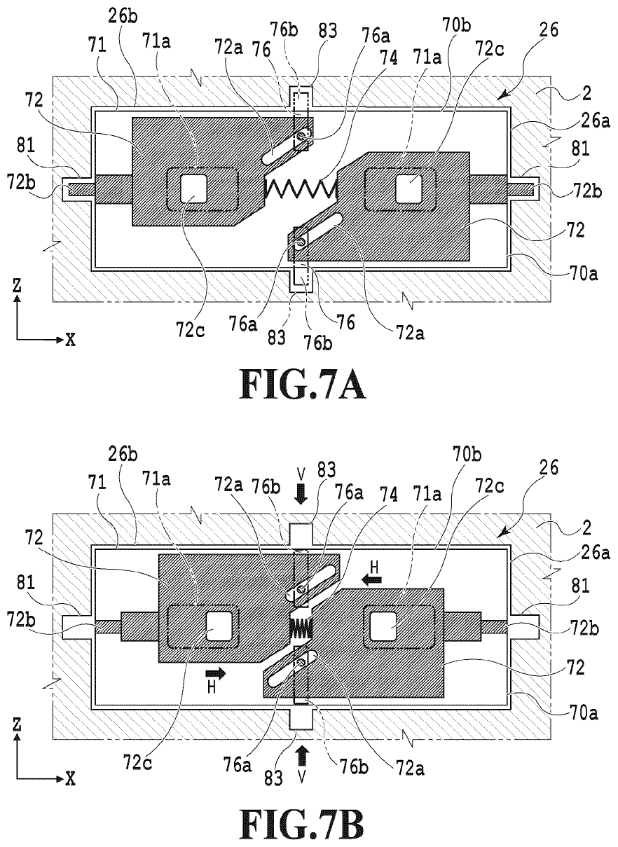

FIGS. 7A and 7B are cross-sectional views of the guide unit 70 according to the first embodiment of the present disclosure, illustrating the structures for attaching and detaching the guide unit 70. Operation portions 72c are provided to restriction units 72 of the guide unit 70, operation windows 71a are formed in a casing 71 of the guide unit 70, and the operation portions 72c are exposed to outside of the operation windows 71a. A user can bring the two operation portions 72c close to each other in the operation windows 71a along operation directions H (FIG. 7B).

As illustrated in FIG. 7A, the guide unit 70 includes the two restriction units 72, and a spring 74 is disposed between the two restriction units 72. By an elastic force of this spring 74, the restriction units 72 are energized along the X direction from an inner side to an outer side of the casing 71 of the guide unit 70. Thus, protrusions 72b of the restriction units 72 can be fitted into first alignment holes 81 formed in second side surfaces 26a of the housing portion 26 of the main body 2.

In addition, each of the restriction units 72 of the guide unit 70 has a sliding groove 72a formed in a long hole shape inclined with respect to the X direction. Bosses 76a of movable units 76 are engaged with these sliding grooves 72a. With this structure, as the restriction units 72 are energized by the elastic force of the spring 74 and moved to the outer side of the guide unit 70, the bosses 76a of the movable units 76 are moved along the sliding grooves 72a in the Z direction and the opposite directions. As a result of the movement, protrusions 76b of the movable units 76 can be fitted into second alignment holes 83 formed in fourth side surfaces 26a of the housing portion 26 next to the second side surfaces 26a.

In order to attach the guide unit 70 to the main body 2, the user moves the restriction units 72 along the operation directions H by inserting his/her fingers into the operation portions 72c. As a result of this operation, the protrusions 72b of the restriction units 72 and the protrusions 76b of the movable units 76 are retracted in the guide unit 70 (see FIG. 7B). In this state, the user places the guide unit 70 at a predetermined position in the housing portion 26 of the main body 2, and removes his/her fingers from the operation portions 72c, thereby causing the above-mentioned movement of the restriction units 72. With this movement of the restriction units 72, the protrusions 72b of the restriction units 72 are fitted into the first alignment holes 81, and, in conjunction with this, the protrusions 76b of the movable units 76 are fitted into the second alignment holes 83, so that the guide unit 70 is attached and fixed to the main body 2.

On the other hand, in order to detach the guide unit 70 from the main body 2, the user moves the restriction units 72 in the operation directions H (see FIG. 7B) by inserting his/her fingers into the operation portions 72c. As a result, the protrusions 72b of the restriction units 72 are released from the first alignment holes 81 and retracted to first side surfaces 70a of the guide unit 70. In addition, the protrusions 76b of the movable units 76 are released from the fitting to the second alignment holes 83. As a result, the guide unit 70 can be detached from the main body 2.

The guide unit may include only the protrusions 72b of the restriction units 72. In this case, the guide unit may be attached to the main body with only the protrusions 72b fitted to the first alignment holes 81.

In the embodiment, the first alignment holes 81 are formed at center positions of the second side surfaces 26a, and the protrusions 72b of the restriction units 72 are made capable of being protruded from or retracted to the center positions of the first side surfaces 70a. The second alignment holes 83 are formed at the center positions of the fourth side surfaces 26b and the protrusions 76b of the movable units 76 are made capable of being protruded from or retracted to the center positions of the third side surfaces 70b. With this structure, the guide unit 70 is attached to the main body 2. Then, while the first separation roller 62 and the second separation roller 63 are rotating and feeding print media 200, the above structure makes it possible to inhibit deformation of the guide unit 70, and accordingly reduce feeding failures of the print media 200 due to a change in the relative positions of the first separation roller 62 and the second separation roller 63.

The second separation roller 63, which is one of the separation rollers of the printing apparatus 1, is attached to the guide unit 70 (see FIGS. 3 and 4). Thus, if the guide unit 70 is detached from the main body 2, the second separation roller 63 can be detached together with the guide unit 70 from the main body 2. Thus, the second separation roller 63, which is decreased in the separation performance due to wearing or the like, can be replaced with a new second separation roller 63. The guide unit 70 after the replacement with the new separation roller is attached to the main body 2 in the aforementioned operation.

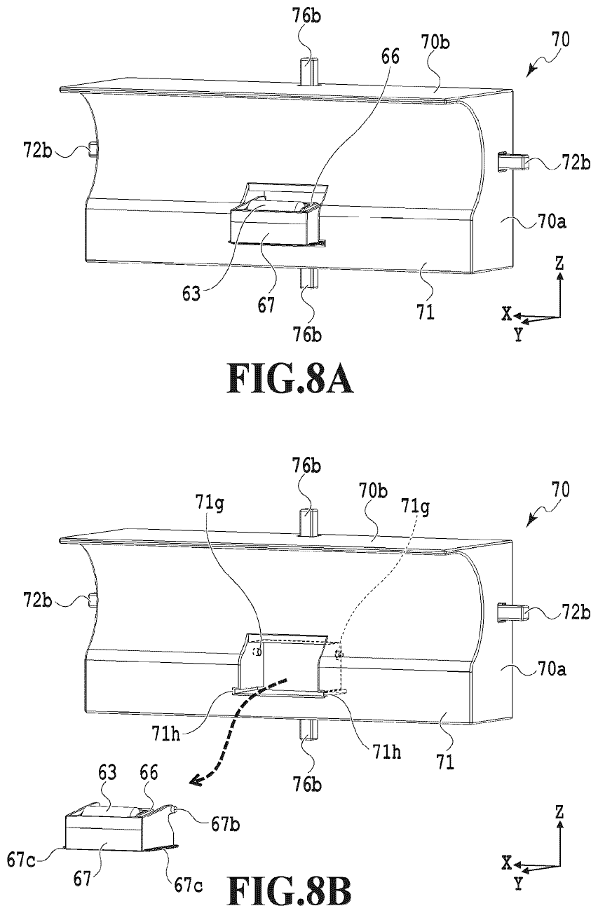

In detail, as illustrated in FIG. 8A, in the case where the guide unit 70 is detached from the main body 2, the second holder 67 to which the second separation roller 63 is attached is exposed from the main body 2, so that the user can touch the second holder 67. Then as illustrated in FIG. 8B, the second holder 67 is pulled out from the guide unit 70 in the Y direction, and the second holder 67 and the second separation roller 63 are together separated from the guide unit 70. Here, the second holder 67 provided with a new second separation roller 63 is attached to the guide unit 70, and the second holder 67 and the guide unit 70 are together attached to the main body 2. Thus, the replacement of the second separation roller 63 is completed.

On the other hand, in order to attach the second holder 67 to the guide unit 70, flange portions 67c of the second holder 67 are slid in grooves 71h of the guide unit 70 along the Y direction. Moreover, bosses 67b of the second holder 67 are fitted into fitting holes 71g of the guide unit 70, so that the second holder 67 is attached to the guide unit 70. An angle and a position of the second holder 67 relative to the guide unit 70 can be determined depending on an angle of the groove 71h with respect to the flange portion 67c and a position of the fitting hole 71g relative to the boss 67b.

In reference to FIG. 5 additionally, the force F₁ illustrated in FIG. 5 acts in the direction opposite to the direction for detaching the second holder 67 and the pressure contact force N illustrated in FIG. 5 acts in a direction substantially orthogonal to the flange portions 67c. Thus, during feeding of the print medium 200, the second holder 67 is not subjected to a force in the direction for detaching the second holder 67 from the guide unit 70, which makes it possible to achieve both ease of replacement of the second holder 67 and a function of holding the second holder 67 in the guide unit 70.

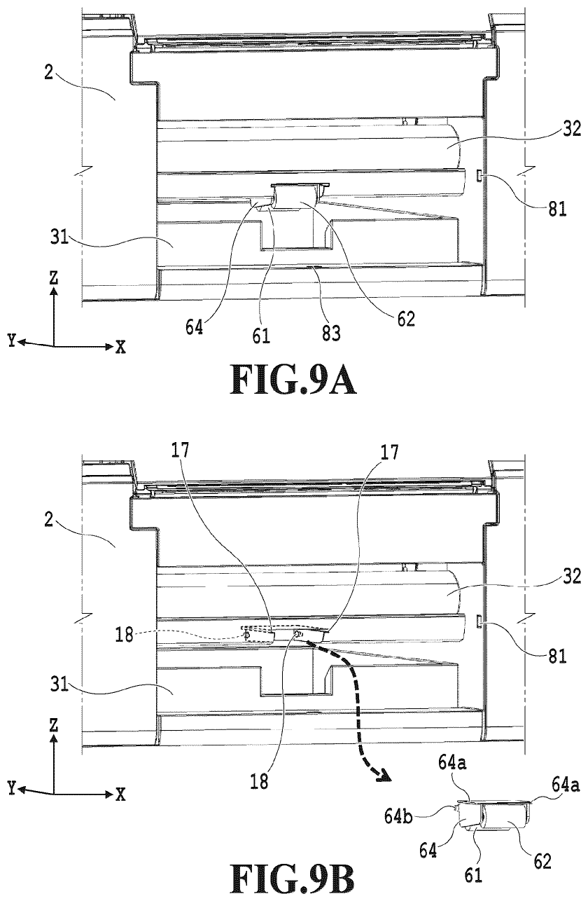

Moreover, in a case where the feeding roller 61 and the first separation roller 62 deteriorate and cannot convey the print medium 200 anymore, it is necessary to replace them with a new feeding roller 61 and a new first separation roller 62. As illustrated in FIG. 9A, in a state where the guide unit 70 is separated from the main body 2, the housing portion 26 of the main body 2 is exposed and the user can touch the first holder 64 to which the feeding roller 61 and the first separation roller 62 are attached. Thus, as illustrated in FIG. 9B, the first holder 64 is pulled out from the main body 2 along the Y direction, and is separated together with the feeding roller 61 and the first separation roller 62 from the main body 2. Then, the first holder 64 provided with a new feeding roller 61 and a new first separation roller 62 is attached to the main body 2, and the replacement of the feeding roller 61 and the first separation roller 62 is completed.

In order to attach the first holder 64 to the main body 2, flange portions 64a of the first holder 64 are slid in grooves 17 of the main body 2 along the Y direction. In addition, bosses 64b of the first holder 64 are fitted to fitting holes 18 of the main body 2, so that the first holder 64 is attached to the main body 2. An angle and a position of the first holder 64 relative to the main body 2 can be determined depending on an angle of the flange portion 64a with respect to the groove 17 and the position of the fitting hole 18 relative to the boss 64b.

In reference to FIG. 5 additionally, the force F₁ illustrated in FIG. 5 acts in the direction opposite to the direction for detaching the first holder 64 and the pressure contact force N illustrated in FIG. 5 acts in the direction substantially orthogonal to the flange portions 64a. Thus, during feeding of the print medium 200, the first holder 64 is not subjected to a force in the direction for detaching the first holder 64 from the main body 2, which makes it possible to achieve both ease of replacement of the first holder 64 and a function of holding the first holder 64 in the main body 2.

Since the guide unit 70 can be easily attached to and detached from the main body 2 in the printing apparatus in the embodiment as described above, the feeding roller 61, the first separation roller 62, and the second separation roller 63 can be easily replaced. In other words, the technologies described in this specification have the potential to contribute to the achievement of a sustainable society, such as a decarbonized society/circular society.

### Embodiment 2

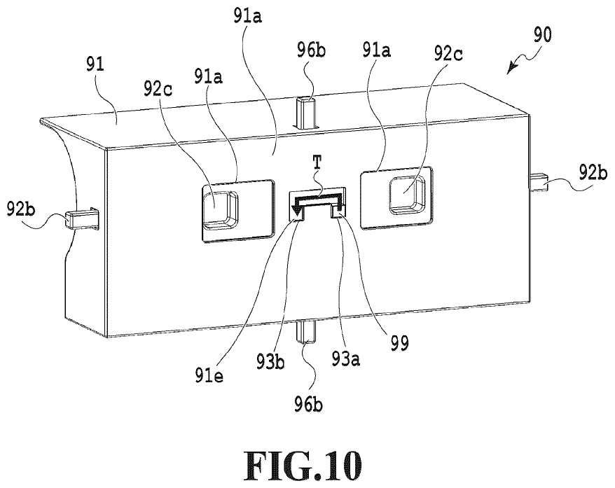

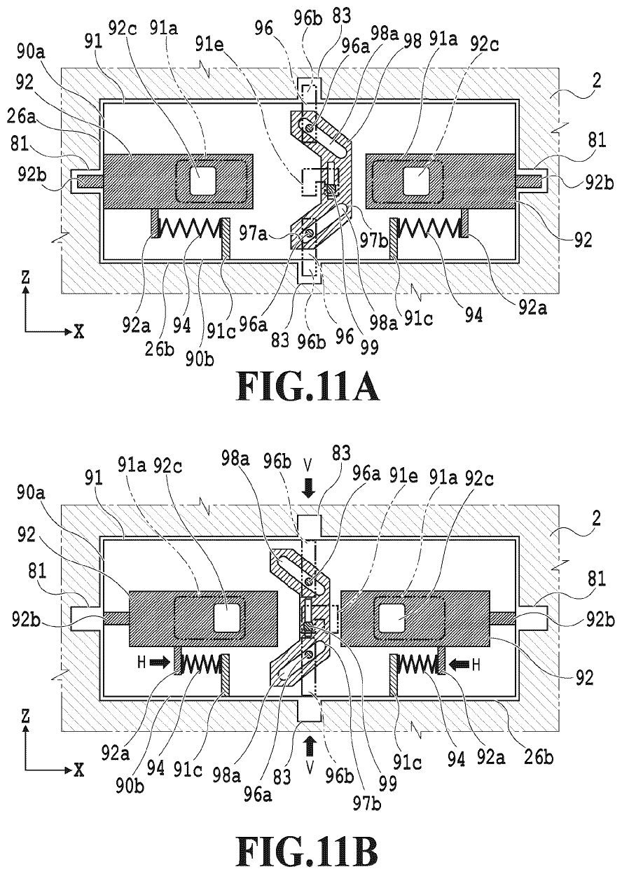

An embodiment illustrated in FIGS. 10, 11A, and 11B is an alternative example similar to the embodiment described in FIGS. 6A to 7B.

FIG. 10 is a perspective view illustrating a guide unit 90 detached from a main body 2 of a printing apparatus 1 according to a second embodiment of the present disclosure. FIGS. 11A and 11B are cross-sectional views of the guide unit 90 according to the second embodiment of the present disclosure, illustrating a structure for attaching and detaching the guide unit 90.

As illustrated in FIGS. 10 and 11A, the guide unit 90 includes two restriction units 92. Each restriction unit 92 includes a first spring stopper 92a. A casing 91 of the guide unit 90 includes two second spring stoppers 91c. The second spring stoppers 91c correspond to the first spring stoppers 92a and a spring 94 is disposed between each of the first spring stopper 92a and the corresponding one of the second spring stoppers 91c. By an elastic force of these springs 94, protrusions 92b of the restriction units 92 are energized along the X direction from an inner side to an outer side of the casing 91 of the guide unit 90. Thus, the protrusions 92b of the restriction units 92 can be fitted into first alignment holes 81 formed in second side surfaces 26a of the housing portion 26 of the main body 2.

In the embodiment, the guide unit 90 includes a moving unit 98, and the moving unit 98 includes an operation portion 99. The operation portion 99 is set in an operation window 91e formed in the casing 91 of the guide unit 90. The moving unit 98 is moved along the X direction with a movement of the operation portion 99 between a first position 93a and a second position 93b in the operation window 91e.

The moving unit 98 includes slide grooves 98a each formed in a long hole shape inclined with respect to the X direction, and bosses 96a of movable units 96 are engaged with the respective slide grooves 98a. With a movement of the operation portion 99 in the operation window 91e, the slide grooves 98a of the moving unit 98 are moved along the X direction, and the bosses 96a of the movable units 96 are moved along the slide grooves 98a in the Z direction and the opposite direction. With this movement, protrusions 96b of the movable units 96 are protruded from or retracted to third side surfaces 90b and can be fitted into second alignment holes 83 (see FIG. 11A) or released from the second alignment holes 83 (see FIG. 11B).

In detail, as illustrated in FIG. 11A, in a state where the operation portion 99 is located at the first position 93a in the operation window 91e, the bosses 96a of the movable units 96 are located at end portions 97a of the slide grooves 98a close to the third side surfaces 90b, and the protrusions 96b of the movable units 96 are protruded from the third side surfaces 90b and can be fitted into the second alignment holes 83.

Therefore, in a case where the operation portion 99 is moved to the first position 93a of the operation window 91e in a state where the protrusions 92b of the restriction units 92 are fitted to the first alignment holes 81 of the housing portion 26, the protrusions 96b of the movable units 96 can be fitted into the second alignment holes 83 of the housing portion 26. In this way, the guide unit 90 can be attached to the main body 2.

On the other hand, as illustrated in FIG. 11B, while the operation portion 99 is being moved along a direction T illustrated in FIG. 10 and located at the second position 93b of the operation window 91e, the moving unit 98 is moved relative to the casing 91 in the X direction and the slide grooves 98a are also moved in the X direction. As a result, the bosses 96a of the movable units 96 are moved along the slide grooves 98a in the Z direction and the opposite direction (V directions illustrated in FIG. 11B). With this movement, the protrusions 96b of the movable units 96 can be released from the second alignment holes 83.

Moreover, in a case where the user brings two operation portions 92c close to each other by moving them in operation windows 91a along the operation directions H, the protrusions 92b of the restriction units 92 are moved along the operation directions H and released from the first alignment holes 81. Therefore, in the case where the operation portions 92c are brought close to each other in a state where the protrusions 96b of the movable units 96 are released from the second alignment holes 83, the protrusions 92b of the restriction units 92 can be released from the first alignment holes 81. Alternatively, in a state where the protrusions 92b of the restriction units 92 are released from the first alignment holes 81, the protrusions 96b of the movable units 96 can be released from the second alignment holes 83. Thus, the guide unit 90 can be detached from the main body 2.

In the embodiment, the operation portion 99 may be given an elastic force in the X direction by an elastic member (not illustrated). With this elastic force, the operation portion 99 is energized in the X direction and is fixed to either of the first position 93a and the second position 93b.

Since the guide unit 90 can be easily attached to and detached from the main body 2 in the printing apparatus in the embodiment as described above, the feeding roller 61, the first separation roller 62, and the second separation roller 63 can be easily replaced. In other words, the technologies described in this specification have the potential to contribute to the achievement of a sustainable society, such as a decarbonized society/circular society.

### Embodiment 3

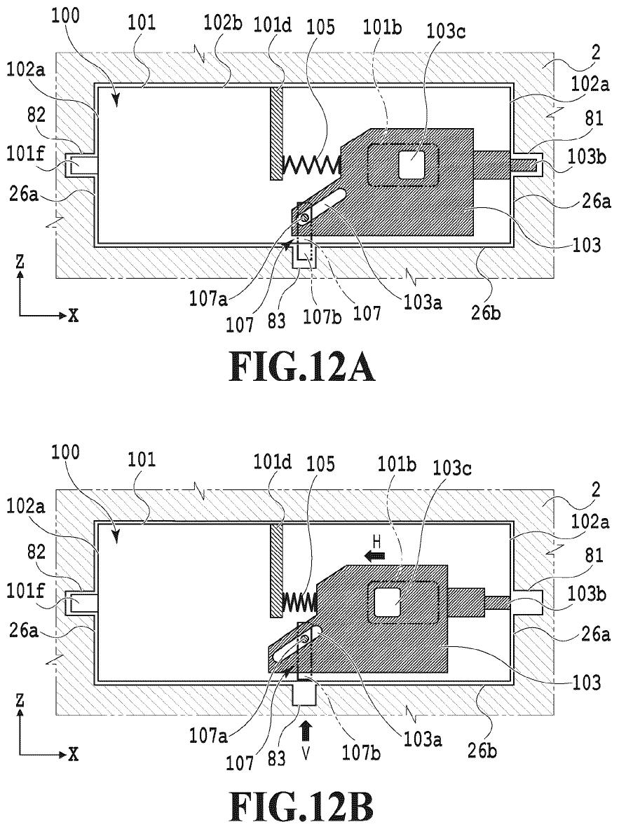

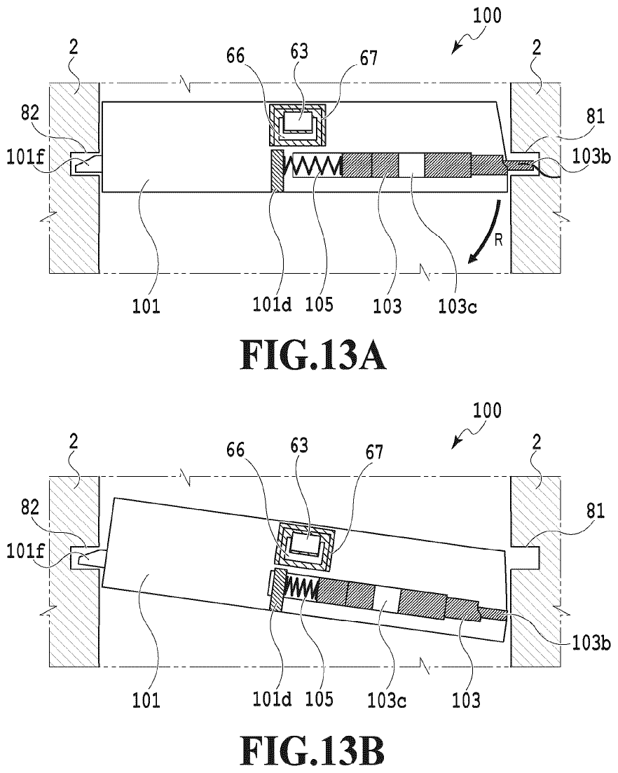

An embodiment illustrated in FIGS. 12A to 13B is an alternative example similar to the embodiment described in FIGS. 6A to 7B.

FIGS. 12A and 12B are cross-sectional views of a guide unit 100 according to a third embodiment of the present disclosure, illustrating a structure for attaching and detaching the guide unit 100.

The guide unit 100 in the embodiment includes one restriction unit 103, and a spring 105 is disposed between the restriction unit 103 and a spring stopper 101d of a casing 101. By an elastic force of the spring 105, a protrusion 103b of the restriction unit 103 is protruded from a first side surface 102a of the casing 101 along the X direction from an inner side of the casing 101 of the guide unit 100 and is fitted into a first alignment hole 81 formed in a second side surface 26a of the main body 2. In detail, the casing 101 includes two first side surfaces 120a opposed to each other, the protrusion 103b of the restriction unit 103 is protruded from one of the first side surfaces 102a, and a fixed portion 101f is formed in the other first side surface 102a. The fixed portion 101f can be fitted into a third alignment hole 82 of the main body 2 opposed to the first alignment hole 81.

On the other hand, the restriction unit 103 has a slide groove 103a formed in a long hole shape inclined with respect to the X direction, and a boss 107a of a movable unit 107 is engaged with the slide groove 103a. While the restriction unit 103 is being moved to an outer side of the guide unit 100 with energization by an elastic force of the spring 105, the slide groove 103a is moved along the X direction, and the boss 107a of the movable unit 107 is moved along the slide groove 103a in the Z direction (see FIG. 12A), so that a protrusion 107b of the movable unit 107 is protruded from a third side surface 102b and can be fitted into a second alignment hole 83.

In this structure, with a movement of the restriction unit 103 in a state where the fixed portion 101f is fitted to the third alignment hole 82 opposed to the first alignment hole 81, the protrusion 103b of the restriction unit 103 is fitted into the first alignment hole 81, and in conjunction with this, the protrusion 107b of the movable unit 107 is fitted into the second alignment hole 83, so that the guide unit 100 is attached and fixed to the main body 2.

As illustrated in FIG. 12B, in order to detach the guide unit 100 from the main body 2, the user inserts his/her finger into an operation portion 103c and moves the restriction unit 103 in an H direction, so that the protrusion 103b of the restriction unit 103 is released from the first alignment hole 81 and retracted to the first side surface 102a of the guide unit 100, and in conjunction with this, the protrusion 107b of the movable unit 107 is released from the fitting to the second alignment hole 83. In this state, the guide unit 100 is rotated about the fixed portion 101f in a direction indicated by an arrow R in FIG. 13A, so that the guide unit 100 can be detached from the main body 2.

Since the guide unit 100 can be easily attached to and detached from the main body 2 in the printing apparatus in the embodiment as described above, the feeding roller 61, the first separation roller 62, and the second separation roller 63 can be easily replaced. In other words, the technologies described in this specification have the potential to contribute to the achievement of a sustainable society, such as a decarbonized society/circular society.

In the foregoing embodiments, the separation rollers are used as the separation members, but an application of the present invention is not limited to this. For example, a friction pad may be used as the separation member. In an embodiment using a friction pad, in a case where multiple print media are fed, their leading edges are brought into contact with an inclined surface of the friction pad, so that the uppermost print medium is separated and fed owing to a relationship of forces acting between the inclined surface and the multiple print media.

In the foregoing embodiments, the protrusion (72b, 92b, or 103b) formed integrally with the restriction unit is configured to be fitted by moving in the direction orthogonal to the short side of the guide unit, but an embodiment is not limited to this. The protrusion (72b, 92b, or 103b) formed integrally with the restriction unit may be configured to be fitted by moving in a direction orthogonal to the longitudinal side of the guide unit.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-074733, filed May 2, 2024, which is hereby incorporated by reference herein in its entirety.

What is claimed is:

1. A printing apparatus comprising:
a main body;
a printing unit configured to print an image on a print medium;
a loading unit configured to load a plurality of print media;
a feeding roller configured to feed the print media loaded on the loading unit;
a guide unit including a guide surface configured to form a part of a conveyance path through which the print media are conveyed from the feeding roller to the printing unit, and an exterior surface located on a side opposite to the guide surface and configured to form an exterior of the main body, the guide unit being detachable from the main body; and
a separation member detachably held by the guide unit, and configured to separate one of a plurality of print media from the other print media in a case where the plurality of print media are fed by the feeding roller, wherein
the guide unit includes at least one restriction unit configured to be moved, with an operation performed on an operation portion, between a position where the restriction unit is engaged with the main body and a position where the restriction unit is disengaged from the main body.

2. The printing apparatus according to claim 1, wherein at least one of the restriction units is disposed to be substantially flush with the separation member in a plane of the guide unit, the plane being orthogonal to a conveyance direction of the print media.

3. The printing apparatus according to claim 1, wherein at least one of the restriction units is energized in a direction in which the restriction unit is to be moved for the engagement.

4. The printing apparatus according to claim 1, wherein
the main body includes a first alignment hole formed in a second side surface of the main body corresponding to a first side surface of the guide unit, and
the restriction unit is configured to be fitted to the first alignment hole and engaged with the main body.

5. The printing apparatus according to claim 4, wherein
the first alignment hole is formed at a center position of the second side surface, and
the restriction unit is capable of being protruded from or retracted to a center position of the first side surface.

6. The printing apparatus according to claim 4, wherein
the guide unit includes a movable unit capable of being protruded from or retracted to a third side surface of the guide unit next to the first side surface,
the main body includes a second alignment hole formed in a fourth side surface of the main body next to the second side surface, and
the movable unit is configured to be releasably fitted to the second alignment hole.

7. The printing apparatus according to claim 6, wherein
the second alignment hole is formed at a center position of the fourth side surface, and
the movable unit is capable of being protruded from or retracted to a center position of the third side surface.

8. The printing apparatus according to claim 6, wherein the guide unit includes a conjunction unit configured to concurrently fit the restriction unit and the movable unit into the first alignment hole and the second alignment hole, respectively, and concurrently release the restriction unit and the movable unit from the first alignment hole and the second alignment hole, respectively.

9. The printing apparatus according to claim 1, wherein the separation member is a separation roller.

10. The printing apparatus according to claim 1, wherein the printing unit is a print head configured to eject ink to a print medium.
